(19) United States
(12) Patent Application Publication
(10) Pub. No.: US 2014/0095192 A1
(43) Pub. Date: Apr. 3, 2014

(54) Product Purchase Multiplier

(71) Applicants: Joseph Ernest Rock, Littleton, MA (US); Mariana Nikolova-Simons, Bolton, MA (US)

(72) Inventors: Joseph Ernest Rock, Littleton, MA (US); Mariana Nikolova-Simons, Bolton, MA (US)

(73) Assignee: KONINKLIJKE PHILIPS ELECTRONICS N.V., EINDHOVEN (NL)

(21) Appl. No.: 14/043,033

(22) Filed: Oct. 1, 2013

Related U.S. Application Data
(60) Provisional application No. 61/708,173, filed on Oct. 1, 2012.

(51) Int. Cl. G06Q 50/22; G06Q 30/02

(52) U.S. Cl. CPC G06Q 50/22; G06Q 30/0283
USPC 705/2; 705/400

(57) ABSTRACT

A method includes determining a food product price multiplier for a food product identified for purchase by an individual based on a health status for the individual and a product health value for the food product and generating an electronic signal indicative thereof. A system includes a multiplier determiner (116) that determines a food product price multiplier for a food product identified for purchase by an individual based on a health status for the individual and a product health value for the food product and generates an electronic signal indicative thereof.

The following generally relates to determining a product purchase multiplier that increases, maintains, or decreases a list price of a product for an individual based on a health status for the individual and a health value of the product, which may influence a food product purchase behavior of the individual.

Healthcare systems and subsequently governments have a vested interest in seeing that individuals who develop chronic conditions behave in a way that is the best for their health. Failing to do so not only jeopardizes the health of the individual but taken at a societal level, compromise the ability for governments to provide care at a reasonable price point for its citizens. Unfortunately, changing the behavior of individuals with disease has been a difficult aspect of disease management.

Generally, individuals who adhere to their care plans and do not engage in behaviors that could either exacerbate or compromise their condition have had outcomes that are markedly improved. However, once outside of the structured environment of a hospital, many individuals fail to comply with either their explicit or implicit care plans. For example, without the managed structure of the hospital, an individual may consume too many calories, fat, cholesterol and/or sodium, may not exercise regularly, continue to smoke and/or drink, etc.

One approach that has been demonstrated to be effective to influence human behavior in connection with the purchase of a product is a government taxation of the product (e.g. cigarettes). However, unlike the case with cigarettes where all consumption is bad and thus could be taxed in an attempt to eradicate smoking, eating certain types of food or amounts of food can be bad or even deadly for one person and may not be bad or even deadly for someone else. For example, eating high sodium food is bad for a person with high blood pressure while might be beneficial for a person with low blood pressure.

Thus, while taxing certain activities may curb the use of that activity, it does not necessarily differentiate between those individuals who may safely participate in the activity from those individuals who cannot. Therefore, there is an unresolved need for other approaches to influence the behavior of individuals in connection with certain activities such as purchasing food products.

Aspects described herein address the above-referenced problems and others.

In one aspect, a method includes determining a food product price multiplier for a food product identified for purchase by an individual based on a health status for the individual and a product health value for the food product and generating an electronic signal indicative thereof.

In another aspect, a system includes a multiplier determiner that determines a food product price multiplier for a food product identified for purchase by an individual based on a health status for the individual and a product health value for the food product and generates an electronic signal indicative thereof.

In another aspect, a computer readable storage medium encoded with computer readable instructions, which, when executed by a processer, causes the processor to: obtain a health status for an individual, wherein the health status is based on medical information of the individual or medical information of a family of the individual, obtain a product health value for a food product identified for purchase by the individual, wherein the product health value is based on a nutrition of one or more individual ingredients of the food product, and determine a food product price multiplier for the food product based on the health status and the product health value, wherein the food product price multiplier increases or decreases a list price of the food product.

The invention may take form in various components and arrangements of components, and in various steps and arrangements of steps. The drawings are only for purposes of illustrating the preferred embodiments and are not to be construed as limiting the invention.

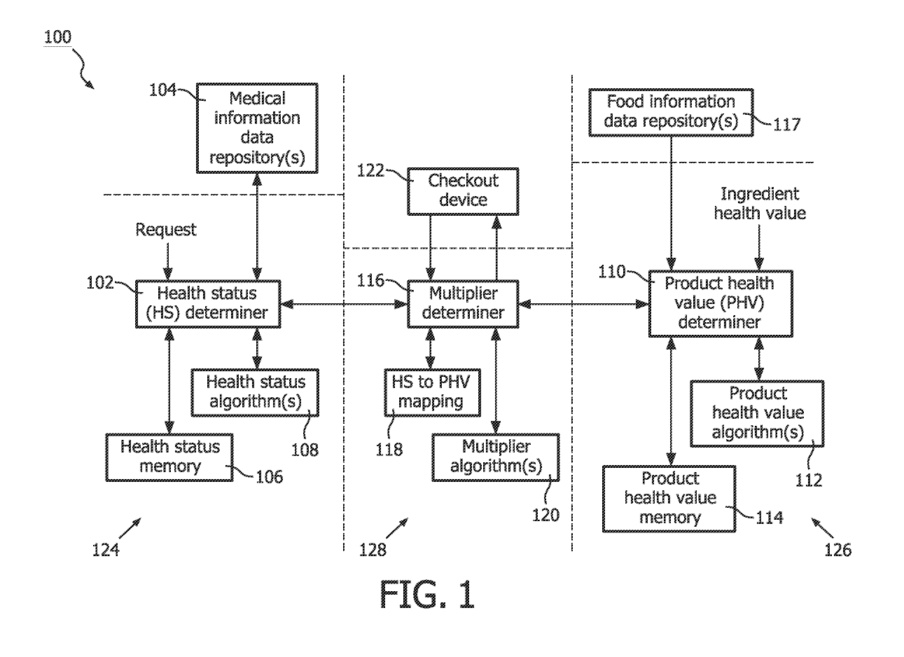

FIG. 1 schematically illustrates a system for determining a food purchase price multiplier for a food product based on a health status for an individual buying the food product and a product health value of the food product.

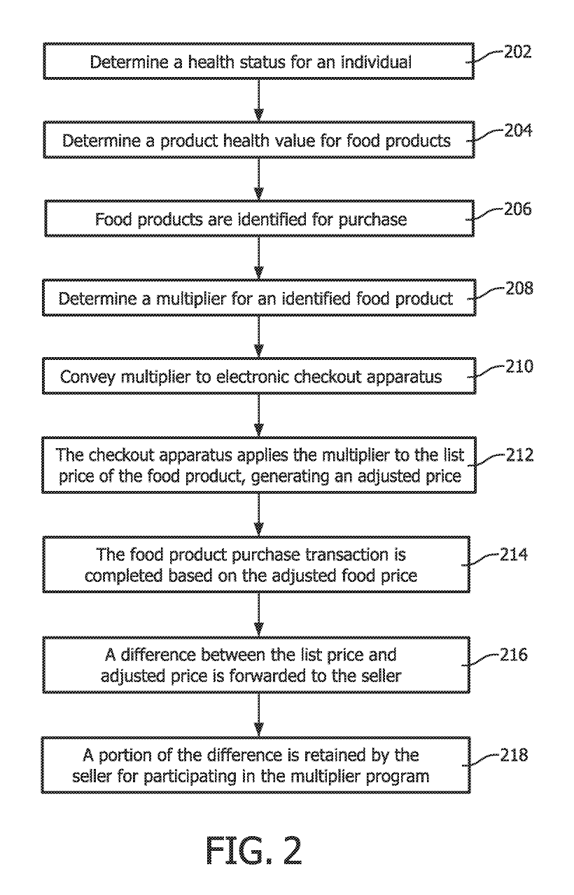

FIG. 2 illustrates an example method for determining a food purchase price multiplier for a food product based on a health status for an individual buying the food product and a product health value of the food product.

The following relates to a method and/or system that influences health related food product choices made by an individual based at least on a health status for the individual. As described in greater detail below, a health status is generated for the individual based on medical information, and when the individual identifies a food product to purchase and/or is purchasing the food product, a multiplier is calculated based on the health status and a health value for the food product, and the multiplier is used to increase, maintain, or decrease the cost to the food product.

As a consequence, the result of the multiplier may affect the choice of which food products are purchased by the individual. In the end, the particular store, restaurant, etc. still retains at least the original list purchase price and may even receive additional money for participating in the program. However, any money collected above and beyond the list price due to the multiplier goes to the health insurer of the individual and/or other entity. Furthermore, any reduction in money collected (the difference between the original list price and the multiplier purchase price) due to the multiplier is reimbursed by the health insurer of the individual to the store, restaurant, etc.

It is to be appreciated that the following may be used by healthcare insurers to not only influence the food products purchased by individuals with disease, but also to influence the food products purchased by individuals identified as prone or at risk to disease, such as an individual developing a chronic condition such as heart failure or diabetes and/or a healthy individual with a family history of chronic disease. For this, the calculation of the multiplier can be modified to accommodate that type of information for reducing or eliminating their risk.

Turning to FIG. 1, a system 100 that calculates food product multipliers is schematically illustrated.

The system 100 includes a health status (HS) determiner 102, which determines a health status for an individual and generates an electronic signal indicative thereof The health status may be a single representative qualitative value (e.g., excellent, good, fair, poor, etc.), a single quantitative value (e.g., 10, 9, 8 etc.), etc., sub-divided by body system (e.g., cardiac, respiratory, endocrine, etc.) with similar subjective and objective scoring per body system, and/or in another format.

Furthermore, the health status can be specific to the individual or specific to a group such as the individual's family. The individual's family, as used herein, includes those likely to consume food products purchased by the individual. For example, the individual's family would include a spouse, children, parents and/or others living with the individual, having authorized access to food products purchased by the individual, and regularly eating meals with the individual. Other groups are also contemplated herein.

In the illustrated example, the health status determiner 102 is invoked to compute a health status based on a request. In one instance, the request includes information that uniquely identifies the individual. Such information can be one or more of a social security number, a driver's license number, a state identification card number, a health insurance identification number, and/or other information that may facilitate uniquely identifying the individual.

The request may be generated when an individual elects to participate under a plan provided by a health care insurer, based on a lapse of time from a previous health status determination (such a request can be internally generated by the health status determiner 102 and/or an external scheduling source), based on an event in the individual's life (e.g., a recent update to the medical information of the individual), on-demand based on a user input to the health status determiner 102, and/or otherwise. The health status determiner 102 obtains medical information about the individual and/or individual's family from one or more data repositories 104. Examples of such data repositories include, but are not limited to a patient archiving and communications system (PACS), a hospital information system (HIS), an electronic medical record (EMR), a personal health record (PHR), a radiology information system (RIS), and/or other storage that stores medical information of an individual(s). The data repositories 104 can be located at a same and/or one or more different locations.

The medical information can include, but is not limited to, disease (e.g., hypertension, diabetes, ischemic stroke, etc.), vital signs (e.g., weight, blood pressure, pulse, temperature, etc.), laboratory values (e.g., Hgb (hemoglobin), WBC (white blood cells), Plt (platelets), Hct (hematocrit), BNP (B-type natriuretic peptide), creatinine, BUN (blood urea nitrogen), etc.), symptoms (e.g., breathing function, fatigues, dyspnoea, etc.), demographics (e.g., age, height, gender, etc.), medication list, dietary intake, activity level, BMI, smoking status, risk of disease, etc. In a variation, the medical information may also include non-medical information.

The health status determiner 102 stores the health status of an individual in health status memory 106. The health status memory 106 can be local to the health status determiner 102, remote from the health status determiner 102, distributed, etc. The memory 106 can be located with the insurer and include health statuses for a plurality of different individuals, or local to a computer, smartphone, tablet computer, etc. of the individual and include the health status for the individual only.

The health status determiner 102 computes a health status for an individual based on one or more health status algorithms 108. A health status algorithm 108 can be specific to a healthcare insurer of the individual. Alternatively, a health status algorithm 108 can be common or shared by multiple healthcare insurers, including the healthcare insurer of the individual. Such an algorithm may be generated and provided by the healthcare insurer, a government and/or other entity.

A product health value determiner 110 determines a product health value for a food product and generates an electronic signal indicative thereof. In the illustrated example, the product health value determiner 110 determines a health value for a food product based on all or a subset of the ingredients of the food product, taken from a food information data repository 117, and a product health value algorithm 112, which takes into account elements such as total calories, total fat, type of fat (saturated, trans), total cholesterol, sodium, proteins, carbohydrates, vitamins and minerals.

The product identification and the individual ingredients thereof are obtained, directly or indirectly, from a manufacturer of the food products and/or otherwise, such as a third party ingredient identifier. An ingredient health value may be specific to a healthcare insurer of the individual and/or common to multiple healthcare insurers, including the healthcare insurer of the individual. Generally, the product health value of a purchase in and of itself cannot be classified as ‘good’ or ‘bad’. That is, something that is fine, even healthy for one individual may be tremendously bad for another.

As an example, consider food product brand X soup with one hundred (100) calories, no fat or cholesterol, six hundred and forty (640) milligrams (mg) of sodium and two (2) grams of protein. Such a soup may generally be considered healthy food choice for an individual without any sodium restrictions on their diet. However, for an individual with a low sodium diet (e.g., max five hundred (500) mg), the amount of sodium in the soup (i.e., 640 mg) could have disastrous health effects.

The product health value determiner 110 stores product health values in product health value memory 114. The product health value memory 114 can be local to the product health value determiner 110, remote from the product health value determiner 110, distributed, etc. The product health value determiner 110 computes a product health value based on a product health value algorithm 112, which may be specific to a healthcare insurer of the individual and/or common to multiple healthcare insurers, including the healthcare insurer of the individual.

For the product health value determined by the product health value determiner 110, initiatives of the governments such as the US government (e.g. ChooseMy Plate.gov from the USDA) can be used to facilitate quantifying the product health value of a single food product. Furthermore, the product health value may be represented through a quantitative value or qualitative, and/or converted there between, and may be aggregated or subdivided into one or more subgroupings.

A multiplier determiner 116 determines a product price multiplier for an individual based on the health status for the individual and the product health values for food products being considered or being purchased by the individual. In the illustrated example, the multiplier determiner 116 utilizes a pre-determined health status to product health value (HS to PHV) mapping 118. The mapping 118 can be in the form of a look up table (LUT), polynomial, etc.

Furthermore, the mapping 118 may be specific to a healthcare insurer of the individual and/or shared by multiple healthcare insurers, including the healthcare insurer of the individual. Table 1 shows an example LUT in which a two-point scale is used for the health status and a three-point scale is used for product heath value. Other scales, dimensions, formats, etc. are also contemplated herein.

TABLE 1
Multiplier LUT

| | Product | | |
|---|---|---|---|
| | Health Value | | |
| Health Status | 1 | 2 | 3 |
| 1 | .90 | 1.0 | 1.5 |
| 2 | .85 | 1.5 | 2.0 |

The multiplier determiner 116 identifies a multiplier for a food product in Table 1 by the intersection of the health status and the product health value pair for the food product. For example, the multiplier determiner 116 identifies a multiplier of one and a half (1.5) for a health status of one (1) and a product health value of three (3). Generally, the change from ‘1.00’ would be the personalized increase or decrease for the individual in the total cost of a purchase of the food product.

In the illustrated example, a checkout device 122 electronically conveys information about food products identified for possible purchase or being purchased and identification of the individual purchasing the food products to the multiplier determiner 116. The multiplier determiner 116, in response, thereto, request a health status for the individual from the health status determiner 102 and product heath values for the products being purchased from the product health value determiner 110.

The multiplier determiner 116 then employs a multiplier algorithm 120 and the HS to PHV mapping 119 to determine a multiplier for each product based on the health status and the product heath value corresponding to the product. The multiplier determiner 116 conveys the multipliers to the checkout device 122, which applies the multipliers to the price of each food product, which increases, decreases, or maintains the original price of each product.

Generally, the checkout device 122 is an apparatus with suitable hardware (e.g., a processor(s) and local and/or portable memory with instructions encoded thereon) and software (e.g., food purchase application) located at the store at which the food products are purchased. Examples of such apparatuses include, but are not limited to, an electronic cash register (also referred to as a point of sale (POS) and a point of purchase (POP)), a credit card reader, a debit card reader, a web application, etc.

It is to be appreciated that the health status determiner 102, the product health value determiner 110 and/or the multiplier determiner 116 can include and/or be implemented via one or more micro-processors executing computer readable/executable instructions encoded on computer readable storage medium (i.e., physical memory or other non-transitory storage medium). The micro-processor may also be configured to execute one or more computer readable/executable instructions carried by a signal, carrier wave or other transitory medium to implement the components 102, 110 and/or 116.

In the illustrated example, the health status determiner 102, the health status algorithm 108 and the health status memory 106 are part of a subsystem 124, the product health value determiner 110, the product health value algorithm 112 and the product health value memory 114 are part of a subsystem 126, and the multiplier 116, the multiplier algorithm 120 and the HS to PHV mapping 118 are part of a subsystem 128. The subsystems 124, 126 and 128 can be part of a same computing system, e.g., a computing system(s) of the healthcare insurer of the individual.

Alternatively, at least one of the subsystems 124, 126 and/or 128 can be part of a different computing system. For example, in one instance, the subsystem 128 may be part of an application employed on an electronic device such as a computer, a smartphone, a laptop, a tablet computer, and/or the like, whereas the subsystems 124 and 126 are part of the computing system of the healthcare insurer. Other arrangements of the subsystems 124, 126 and 128 are also contemplated herein.

The system 100 calculates multipliers to be used with a food product purchase of an individual. Since a value of a multiplier can increase or decrease the total cost of a purchase and is dependent on a health value of a product and a health status of an individual, the individual's choice of food products will influence the total cost of the purchase. In one instance, this allows a healthcare insurer to influence what an individual purchase's, for example, in connection with managing an individual with disease or at risk of disease by setting food product health values to encourage or discourage purchase of food products with particular ingredients.

By way of non-limiting example, given an individual with known heart failure who is about to purchase a high sodium lunch, since there is a significant negative relationship, the multiplier will increase (i.e., be greater than one) the total purchase cost. Given an individual without heart failure and normal vital signs who is about to purchase the high sodium lunch, the multiplier will be relatively smaller. Where either individual is about to purchase apples, the multiplier may be one, resulting in no change, or less than one, resulting in a reduction in the price. An expectation is that by influencing the purchase price, personal behavior can be changed.

As discussed above, the health status determiner 102 employs one or more heath status algorithms 108 to determine a health status. The following describes example suitable algorithms, including an algorithm for determining a health status for an individual based solely on the individual as a whole, an algorithm for determining a health status for an individual based solely on the individual for the several anatomical subsystems of the individual, and an algorithm for determining a health status for an individual based on the family of the individual, including individuals as a whole or individuals based on anatomical subsystem.

An algorithm for determining a health status (HS) for an individual based solely on the individual as a whole is shown in EQUATION 1:

HS=Σᵢ₌₁ⁿ(ωᵢIᵢ), EQUATION 1:

where Iᵢ represents the ith item of information (e.g., weight, smoking status, BMI, etc.), ωᵢ represents a predetermined weight of the ith item of information, and n represents the number of the individual items of information, and the health status is calculated as a summation of a product of the individual items of information and the corresponding weights.

Optionally, the health status determiner 102 can convert the quantitative health status value HS into a qualitative metric. For example, the following shows a binary translation:

If HS>65% of maximum score, report ‘HEALTHY’, and

Else, report ‘UNHEALTHY’.

In another example, the following shows an N-point (N=5 in this example) binary translation:

If HS>80% of maximum possible score, report ‘Excellent’,

Else if HS>60% of maximum possible score, report ‘Very Good’,

Else if HS>40% of maximum possible score, report ‘Good’,

Else if HS>20% of maximum possible score, report ‘Fair’, and

Else, report ‘Poor’.

An algorithm for determining a health status for an individual based solely on the individual and independently for several different anatomical subsystems is discussed next. EQUATION 2 shows an algorithm for determining the health status for anatomical subsystem X (HS_{systemX}):

HS_{systemX}=Σᵢ₌₁ⁿ(ω_{systemXi}I_{systemXi}). EQUATION 2:

where X represents the xth anatomical subsystem, Iᵢ represents the ith item of information relevant for the anatomical system X, ωᵢ represents a predetermined weight of the ith item of information for the anatomical system X, and n represents the number of the individual items of information for the anatomical system X. Each anatomical subsystem score HS_{systemX} could then be converted to a qualitative metric as shown below:
Cardiac subsystem: 3 (Good);
Respiratory subsystem: 5 (Excellent);
Neuro subsystem: 5 (Excellent);
Digestive subsystems: 4 (Very good).

An algorithm for determining a health status for an individual based on the family of the individual (FHS) is shown in EQUATION 3:

FHS=Σᵢ₌₁ⁿ(ωᵢHSᵢ). EQUATION 3:

where HSᵢ represents the health status for the ith individual of the family (the HS for each family member can be determined based on EQUATION 1 or 2), ωᵢ represents the weight for the ith individual, and n represents the number of family members.

The following shows an example of the weights for a family of four with different heath statuses.

| Family Member | Individual Health (HSᵢ) | Weight(ωᵢ) |
|---|---|---|
| Mother (n = 1) | 4 | .3 |
| Father (n = 2) | 2 | .4 |
| Son 1 (n = 3) | 5 | .15 |
| Son 2 (n = 4) | 5 | .15 |

In this instance, the weights sum to the numerical value of one (1). The individual weights can be determined by the healthcare insurer and/or other party. For the above example, a 5-point scale is used. However, other scales can alternatively be used. Likewise, the FHS can be converted to a qualitative metric using the binary, N-point and/or other translation.

The following describes an example where the product health value determiner 110 determines a product health value independently for each anatomical subsystem and generates an aggregated product health value based thereon. In this implementation, each anatomical subsystem is scored independently against each particular nutritional element and then aggregated. After each system is scored, the aggregated product health value (APHV) can be calculated as shown in EQUATION 4:

HI=g(Σf(x,y)), EQUATION 4:

where x represents the anatomical subsystem, y represents the nutrients, f is the function that evaluates the health value of each nutrient on anatomical subsystem, and g is the function that sums the health values to generate the APHV.

EQUATION 4 is well-suited to facilitate differentiating between an individual, e.g., who has a low neuro score (e.g. poor neurological function) but normal cardio and urinary scores, where having increased sodium in their diet may have no impact, and another individual with normal neuro and cardio scores but a poor urinary scores, where having increased sodium in their diet could severely impact their health.

The system 100 can be implemented as a free or fee based subscription service. For example, the system 100 can be offered to a healthcare insurer who would make the service available to its insured, such as a family comprised of mom, dad, son and daughter. The healthcare insurer may mandate the use of the service as part of the terms of the issuance of insurance or may entice insured to use the software by reducing their premium payments. The healthcare insurer could contract with one or more grocery stores, one or more restaurants, etc. to also offer the service at the point of checkout. The healthcare insurer may choose to share a portion of the proceeds with the establishment for their willingness to participate in the program.

In this example, one of the family members (or an individual shopping on behalf of the family) goes grocery shopping at a participating grocery store. In this example, the family member has a mobile electronic device that is running the insured portion of the software application and the grocery store has an electronic register that is running the checkout portion of the software application. As the food products selected by the family member are scanned for purchase, the product health value of each food product is obtained by the mobile electronic device of the family member(s), which determines the multiplier as described herein (using the HS to PHV mapping 118) based on the health status of the family member or the family and the product health value. The device may be preloaded with the health status or the health status can be dynamically obtained.

Where the price of a food product is $1.00 and the multiplier is 1.10, the checkout device 122 presents a total price for the food product as $1.10. Where the price of a food product is $1.00 and the multiplier is 0.90, the checkout device 122 presents a total price for the food product as $0.90. Where the price of a food product is $1.00 and the multiplier is 1.00, the checkout device 122 presents a total price for the food product as $1.00. This process is repeated for each scanned food product. At the end of some predetermined time period (e.g., each purchase, the end of the day, etc.), the grocery store calculates the total that is owed to the healthcare insurer for all individual shoppers and processes a payment in that amount to the healthcare insurer. The healthcare insurer may return a predetermined percentage of that amount to the grocery store for participating in the program.

In a variation, the family member scans the bar code of food products while shopping using a bar code reading application installed on her/his device and/or apparatus, and the device or other apparatus dynamically calculates and displays the product health value of the food product. This in turn leads to the calculation of the multiplier for that particular food product, which would be displayed to family member. In this way, the family member receives real-time feedback about the impact of the purchase of that particular food product. The system 100 could be practiced in a wide variety of settings, including offered to insurers who could then encourage or require the use of the algorithm/software by the insured, as just discussed. A large insurer could also partner with large grocery stores, restaurant chains to voluntarily institute the checkout side of the solution. The system 100 could also be offered to Medicare and use of the system 100 mandated by law.

Although the above has generally been discussed in connection with food products, other products, such as exercise equipment, transportation devices (e.g., bicycle vs motor powered automobile), apparel (e.g., tennis shoes vs sandals), etc. are also contemplated herein.

It is also to be appreciated that an individual could use the multiplier algorithm of a healthcare insurer to facilitate selecting a healthcare insurer. The selections can be based purely on the increase and decrease in price offered through the healthcare insurer. In another instance, this information can be weighed against other factors such as the deductible, the premium, the coverage, etc.

A healthcare insurer may also offer incentives that lower a multiplier. For instance, for a particular product such as a soup, the healthcare insurer may reduce a multiplier by a predetermined percent, value, etc. if the individual also purchases brand X's blood pressure monitor.

A history of the multipliers (with or without an identification of the food products) can be stored and/or electronically sent to an electronic device of a physician of the individual, the individual, a guardian of the individual, etc. A multiplier may also invoke conveyance of a message to the physician of the individual, the individual, a guardian of the individual, etc. For example, where the multiplier indicates an increase or decrease beyond a predetermined threshold, the system 100 may send a warning indicating the individual purchased a product deemed a poor choice or a good choice.

FIG. 2 illustrates an example method for determining a food purchase price multiplier for a food product based on a health status for an individual buying the food product and a product health value of the food product.

It is to be appreciated that the ordering of the acts in the methods described herein is not limiting. As such, other orderings are contemplated herein. In addition, one or more acts may be omitted and/or one or more additional acts may be included.

At 202, a health status for an individual is determined as described herein. The health status could be based solely on the individual or on a group such as a family unit in which the individual is a member and could be specific to a healthcare insurer or shared across healthcare insurers.

At 204, a product health value for a plurality of food products is determined as described herein. The product health value could be specific to a healthcare insurer or shared across healthcare insurers.

At 206, the individual (or a representative thereof) identifies food products for purchase as described herein. For example, identification may be through scanning a food product at the checkout, scanning bar code while shopping, adding a food product to an electronic shopping cart via online shopping, etc.

At 208, for each of all or a subset of the identified food products, a multiplier is determined as described herein. The multiplier can be determined by a computing device at the healthcare insurer, by the seller of the food product (e.g., shopping center, restaurant, etc.), and/or through a mobile electronic device of the individual.

At 210, each determined multiplier is conveyed to the electronic checkout apparatus.

At 212, the electronic checkout apparatus applies each multiplier to the original list purchase price of the corresponding food product, thereby determining an adjusted price for each food product. As described herein, a multiplier may increase, maintain or decrease the price of the food product.

At 214, the individual completes the food product purchase at the adjusted prices.

At 216, the seller of the food product determines a difference between the list price and the adjusted price for each food product, and forwards the difference amount to the healthcare insurer.

At 218, optionally, the healthcare insurer offers part of the difference amount to the seller for participating in the multiplier program.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
determining a food product price multiplier for a food product identified for purchase by an individual based on a health status for the individual and a product health value for the food product and generating an electronic signal indicative thereof

2. The method of claim 1, further comprising:
conveying the multiplier to an electronic checkout device which applies the food product price multiplier to a list price of the food product to adjust the price of the food product.

3. The method of claim 2, wherein the multiplier has a value greater than one, thereby increasing the list price.

4. The method of claim 2, wherein the multiplier has a value less than one, thereby decreasing the list price.

5. The method of any of claims 1 to 4, further comprising:
determining the health status based on medical information of the individual.

6. The method of any of claims 1 to 4, further comprising:
determining the health status based on medical information of a family of the individual.

7. The method of claim 6, further comprising:
determining the health status based on a weighted combination of health statuses of the individual family members.

8. The method of any of claims 5 to 7, further comprising:
determining the health status based on the individual as a whole.

9. The method of any of claims 5 to 7, further comprising:
determining the health status based on a combination of health statuses for individual anatomical subsystems of the individual.

10. The method of any of claims 1 to 9, further comprising:
determining the health status using an algorithm provided by a healthcare insurer of the individual.

11. The method of any of claims 1 to 10, further comprising:
determining the product health value based on a nutrition of one or more individual ingredients of the food product.

12. The method of claim 11, further comprising:
obtaining the product health value from at least one of a healthcare insurer or a government agency.

13. The method of any of claims 1 to 12, further comprising:
determining the food product price multiplier from a predetermined mapping of health status to product health value, which maps a health status/product health value pair to a predetermined multiplier value.

14. A system, comprising:
a multiplier determiner (116) that determines a food product price multiplier for a food product identified for purchase by an individual based on a health status for the individual and a product health value for the food product and generates an electronic signal indicative thereof.

15. The system of claim 14, wherein the multiplier determiner conveys the multiplier to an electronic checkout device which applies the food product price multiplier to a list price of the food product to adjust the price of the food product.

16. The system of claim 14, wherein the multiplier has a value greater than one or less than one, thereby increasing or decreasing the list price.

17. The system of any of claims 14 to 16, further comprising:
a health status determiner (102) that determines the health status based on medical information of the individual or medical information of a family of the individual.

18. The system of claim 17, wherein the health status determiner determines the health status based on the individual as a whole.

19. The system of claim 17, wherein the health status determiner determines the health status based on a combination of health statuses of individual anatomical subsystems of the individual or the family of the individual.

20. The system of any of claims 14 to 19, further comprising:
a product health value determiner (110) that determines the product health value based on a nutrition of one or more individual ingredients of the food product.

21. The system of any of claims 14 to 20, wherein the multiplier determiner determines the food product price multiplier from a predetermined mapping of health status to product health value, which maps a health status/product health value pair to a multiplier value.

22. A computer readable storage medium encoded with computer readable instructions, which, when executed by a processer, causes the processor to:
obtain a health status for an individual, wherein the health status is based on medical information of the individual or medical information of a family of the individual;
obtain a product health value for a food product identified for purchase by the individual, wherein the product health value is based on a nutrition of one or more individual ingredients of the food product; and
determine a food product price multiplier for the food product based on the health status and the product health value, wherein the food product price multiplier increases or decreases a list price of the food product.
